(19) United States
(12) Patent Application Publication
(10) Pub. No.: US 2010/0214415 A1
(43) Pub. Date: Aug. 26, 2010

(54) SYSTEM AND METHOD FOR PROTECTING AND MANAGING CHILDREN USING WIRELESS COMMUNICATION NETWORK

(76) Inventor: Sang Rae Park, Seoul (KR)

Correspondence Address: HARNESS, DICKEY, & PIERCE, P.L.C, 7700 Bonhomme, Suite 400, ST. LOUIS, MO, 63105, US

(21) Appl. No.: 12/682,696

(22) PCT Filed: Oct. 15, 2008
(86) PCT No.: PCT/KR08/06082

§ 371 Date: Apr. 12, 2010

(30) Foreign Application Priority Data
Oct. 16, 2007 (KR) 10-2007-0103938
Oct. 14, 2008 (KR) 10-2008-0100674

(51) Int. Cl. H04N 7/18; H04W 4/00; G06F 15/16

(52) U.S. Cl. 348/158; 455/422.1; 709/203

(57) ABSTRACT

A system and a method for protecting and managing children by using a wireless communication network are provided. The system includes a portable recorder and a user terminal. The portable recorder acquires and stores video information and audio information and transmits the video information and audio information via a wireless communication network in response to an information request received via the wireless communication network. The user terminal transmits the information request via the wireless communication network and receives and replays the video information and audio information transmitted in response to the information request. The system allows it to be possible to check and manage a situation and a state of children anytime anywhere.

### TECHNICAL FIELD

The present invention relates to a system for protecting and managing children, and more particularly, to a system and a method for protecting and managing children far-off by monitoring movements and a surrounding situation of the children in real-time.

### BACKGROUND ART

Due to lack of an ability of recognizing a situation and determining and managing the same, children always need to be protected. However, as a society becomes complicated and nuclear families are increased, it is impossible to guardians such as parents to always protect children. For guardians who cannot personally care their children, there are provided various methods of indirectly protect the children.

As a representative method, there is a method of directly monitoring movements of children by installing audiovisual systems such as a closed-circuit television (CCTV) in places where children move. However, in the case of such method, when children are out of an area where audiovisual systems are installed, it is impossible to check the behavior and situation of children.

To solve this problem, there is provided a method of detecting a location of a child in real-time by monitoring a location of a wireless device carried by the child. However, in the case of such method, it is impossible to check whether the wireless device is departed from the child. Also, only the location of the child can be detected. It is impossible to recognize a situation of the child and to protect the child well.

Also, there is a provided a system for checking a location of a child by carrying a radio frequency identification (RFID) tag and installing an RFID reader in a lot of places in an area. In the case of such system, though the cost of an RFID itself is cheap but there are required many difficulties and costs to introduce basic facilities to embody a whole system. That is, since RFID readers are installed for each area and facility, there is required a large amount of costs and times to introduce nationwide basic facilities. Also, since it is difficult to install RFID readers in all facilities where children move, there are many problems such as blind spots.

Accordingly, there is required a new method capable of recognizing a situation and state of children anytime anywhere.

### DETAILED DESCRIPTION OF THE INVENTION

### Technical Problem

The present invention provides a system capable of protecting and managing children far-off by monitoring the behavior and surrounding state of the children in real-time using a wireless communication network.

The present invention also provides a method of protecting and managing children far-off by monitoring the behavior and surrounding state of the children in real-time using a wireless communication network.

### Technical Solution

According to an aspect of the present invention, there is provided a system for protecting and managing children, the system including a portable recorder and a user terminal. The portable recorder acquires and stores video information and audio information and transmits the video information and the audio information via a wireless communication network in response to an information request received via the wireless communication network. The user terminal transmits the information request via the wireless communication network and receives and replays the video information and the audio information transmitted in response to the information request.

The user terminal may further transmit an audio notification message via the wireless communication network. The portable recorder may further receive and broadcast the audio notification message.

The portable recorder may transmit the video information and the audio information in response to an urgent request via the wireless communication network, In this case, the system may further include a management server receiving and storing the video information and the audio information transmitted in response to the urgent request and transmitting an urgent message to a designated terminal corresponding to a previously designate number.

The designated terminal may be the user terminal.

The portable recorder may include a video information acquisition unit, an audio information acquisition unit, an information storage unit, a wireless communication module, and a control unit. The video information acquisition unit and audio information acquisition unit acquire the video information and the audio information, respectively. The information storage unit stores the acquired video information and audio information. The wireless communication module communicates with the wireless communication network, receives the information request, and transmits the video information and the audio information. The control unit controls operations of the video information acquisition unit, the audio information acquisition unit, the information storage unit, and the wireless communication module in response to one of the information request and the urgent request.

The wireless communication network may employ one or more of a code division multiple access (CDMA) method, a global system for mobile communication (GSM) method, a wireless broadband (Wibro) method, and a wideband CDMA (WCDMA).

According to another aspect of the present invention, there is provided a method of protecting and managing children, the method including: transmitting, by a user terminal, an information request via a wireless communication network; receiving, by a portable recorder, the information request via the wireless communication network; transmitting, by the portable recorder, acquired and stored video information and audio information in response to the information request; and receiving and replaying, by the user terminal, the video information and audio information transmitted via the wireless communication network.

The method may further include: transmitting, by the user terminal, an audio notification message via the wireless communication network; and receiving and broadcasting, by the portable recorder, the audio notification message.

The method may further include: transmitting, by the portable recorder, the video information and audio information via the wireless communication network in response to an urgent request; receiving and storing, by a management server, the video information and audio information transmitted in response to the urgent request; and transmitting, by the management server, an urgent message to a designated terminal corresponding to a previously designated number.

According to still another aspect of the present invention, there is provided a system for protecting and managing children, the system including: a portable recorder, a management server, and a user terminal.

The portable recorder transmits present position information and state information for each predetermined time interval, acquires and stores video information and audio information, and transmits the video information and audio information via a wireless communication network in response to an information request received via the wireless communication network.

The management server determines an activity area where the portable recorder exists for each time period, in response to activity area setting information, transmits an alarm signal when the portable recorder leaves the activity area, based on the present position information, transmits the information request to the portable recorder, stores the video information, the audio information, the present position information, and the state information, and transmits the present position information, the video information, and the audio information to a National Police Agency (NPA) server in response to a predetermined user order.

The user terminal transmits the information request to the management server, receives and replays the video information and the audio information transmitted in response to the information request from the management server, receives the alarm signal, and generates the user order.

The portable recorder may include a speaker receiving an audio signal from the user terminal via the wireless communication network and transmitting audio to an owner of the portable recorder.

The portable recorder may transmit the stored video information and audio information to the management server and the user terminal in response to an emergency signal when an emergency button is operated, and the user terminal may replay and check the video information and the audio information and perform one of accessing the NPA server and generating the user order.

The alarm signal may be one of a text message and an audio signal. The wireless communication network may employ one of a CDMA method, a GSM method, a Wibro method, and a WCDMA method.

The portable recorder may include: a video information acquisition unit acquiring the video information; an audio information acquisition unit acquiring the audio information; an information storage unit storing the acquired video information and audio information; a wireless communication module communicating with the wireless communication network, receiving the information request, and transmitting the video information and the audio information; and a control unit controlling operations of the video information acquisition unit, the audio information acquisition unit, the information storage unit, and the wireless communication module in response to one of the information request and the emergency signal generated by the operation of the emergency button.

The state information may include a state of a battery of the portable recorder, a state of a global position system (GPS) signal, a state of a connection of the wireless communication network, and a state of a self-test of the portable recorder.

### ADVANTAGEOUS EFFECTS

As described above, the system for protecting and managing children according to an embodiment of the present invention has an advantage of checking and dealing with a situation and a state of children anytime anywhere. That is, the system may allow guardians to monitor video, audio, and a situation of children in real-time by using a portable recorder at anytime anywhere and to instantly control movements of children by broadcasting a voice far-off. Also, when children push an emergency button in an emergency, video, audio and a text message on the emergency are transmitted to a management server and a designated terminal to directly call for help and inform a police department of the emergency in such a way that investigation information can be provided to the police department before crimes.

### BRIEF DESCRIPTION OF THE DRAWINGS

FIG. 1 is a configuration diagram illustrating a children protection and management system according to an embodiment of the present invention;

FIG. 2 is a block diagram illustrating a portable recorder of FIG. 1;

FIG. 3 is a flowchart illustrating a children protection and management method according to an embodiment of the present invention;

FIG. 4 is a flowchart illustrating operations for broadcasting an audio notification message, further included in the method of FIG. 3;

FIG. 5 is a flowchart illustrating operations for transmitting an urgent message in response to an urgent request, further included in the method of FIG. 3; and

FIG. 6 is a diagram illustrating a children protection and management system according to another embodiment of the present invention.

### BEST MODE FOR CARRYING OUT THE INVENTION

To fully understand the advantages on operations of the present invention and the object achieved by embodiments of the present invention, the attached drawings illustrating the preferable embodiments of the present invention and the contents therein should be referred.

Hereinafter, the preferable embodiments of the present invention will be described with reference to the attached drawings. The same reference numbers are used throughout the drawings to refer to the same or like parts.

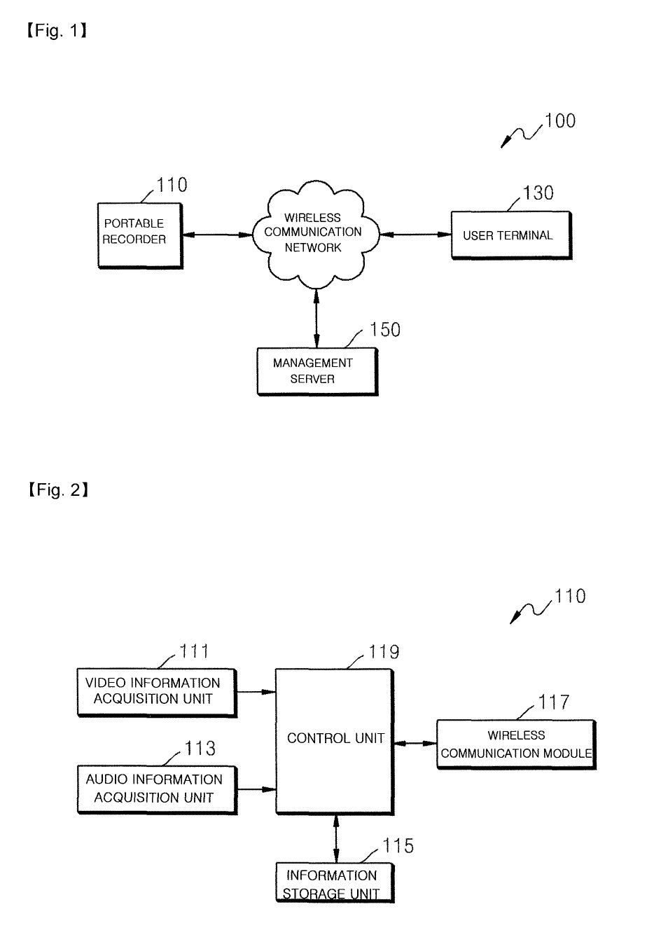

FIG. 1 is a configuration diagram illustrating a children protection and management system 100 according to an embodiment of the present invention. The children protection and management system 100 includes a portable recorder 110 and a user terminal 130 and may further include a management server 150. The portable recorder 110 may be always carried by a child and continuously acquires and stores video information and audio information on a situation where the child is placed in. A guardian for the child transmits an information request and checks video information and audio information transmitted in response to the information request by using the user terminal 130, thereby checking the situation where the child is placed at present.

On the other hand, to better protect and manage children, a user may further transmit an audio notification message via a wireless communication network by using the user terminal 130. In this case, the portable recorder 110 may further receive the audio notification message and broadcast the received audio notification message by using a broadcasting device (not shown) such as a speaker.

The management server 150 performs a predetermined operation in response to an inputted urgent request in an urgent situation such as a case where children are placed in a danger situation. Also, the wireless communication network employs one or more of a code division multiple access method, a global system for mobile communication (GSM) method, a wireless broadband (Wibro) method, and a wideband CDMA (WCDMA).

Referring to FIG. 1, the portable recorder 110 continuously acquiring and storing the video information and audio information transmits the acquired video information and audio information via the wireless communication network in response to the information request received via the wireless communication network. In this case, the transmitted video information and audio information may be acquired before and after a point in time when the information request is received.

FIG. 2 is a block diagram illustrating the portable recorder 110. Referring to FIG. 2, the portable recorder 110 includes a video information acquisition unit 111, an audio information acquisition unit 113, an information storage unit 115, a wireless communication module 117, and a control unit.

The video information acquisition unit 111 and the audio information acquisition unit 113 acquire the video information and the audio information, respectively. The information storage unit 115 stores the acquired video information and audio information. The wireless communication module 117 is connected to the wireless communication network, receives the information request, and transmits the video information and audio information. The control unit 119 controls operations of the video information acquisition unit 111, the audio information acquisition unit 113, the information storage unit 115, and the wireless communication module 117, in response to one of the information request and the urgent request.

Referring to FIG. 1, the user terminal 130 transmits the information request via the wireless communication network and receives and replays the video information and audio information transmitted in response to the information request.

As described above, the children protection and management system 100 may further include the management server 150. The management server 150 may be used in an urgent situation. For example, when a child is kidnapped or an accident happens to the child, an urgent request may be generated automatically or using an urgent situation input unit (not shown) such as an emergency button installed in a portable recorder.

When an urgent request is generated, the portable recorder 110 transmits video information and audio information acquired and stored in a situation corresponding to the urgent request to the management server 150 via the wireless communication network, in response to the urgent request. In this case, the management server 150 receives and stores the video information and audio information transmitted in response to the urgent request and transmits an urgent message to a designated terminal corresponding to a previously designated number. In this case, to be instantly checked by a guardian, the designated terminal may be the user terminal 130.

Hereinafter, the configuration and operations of the children protection and management system 100 will be described with reference to FIG. 3. FIG. 3 is a flowchart illustrating a children protection and management method according to an embodiment of the present invention.

When a guardian wants to check a situation where a child is placed in at present, a user transmits an information request to the portable recorder 110 via the wireless communication network by using the user terminal (S301). On the other hand, the portable recorder 110, in detail, the wireless communication module 117 receives the information request transmitted from the user terminal via the wireless communication network (S303). The control unit 119 controls the video information acquisition unit 111 and the audio information acquisition unit 113 to acquire video information and audio information on a situation where a child is placed in, respectively. Also, the control unit 119 may store the acquired video information and audio information in the information storage unit 115.

Also, the control unit 119 controls the wireless communication module 117 to transmit the video information and audio information acquired via the wireless communication network to the user terminal 130 (S305). After that, the user terminal 130 receives and replays the video information and audio information transmitted from the portable recorder 110 (S307). Accordingly, a user may check video and audio of the situation where the child is placed in, real-time.

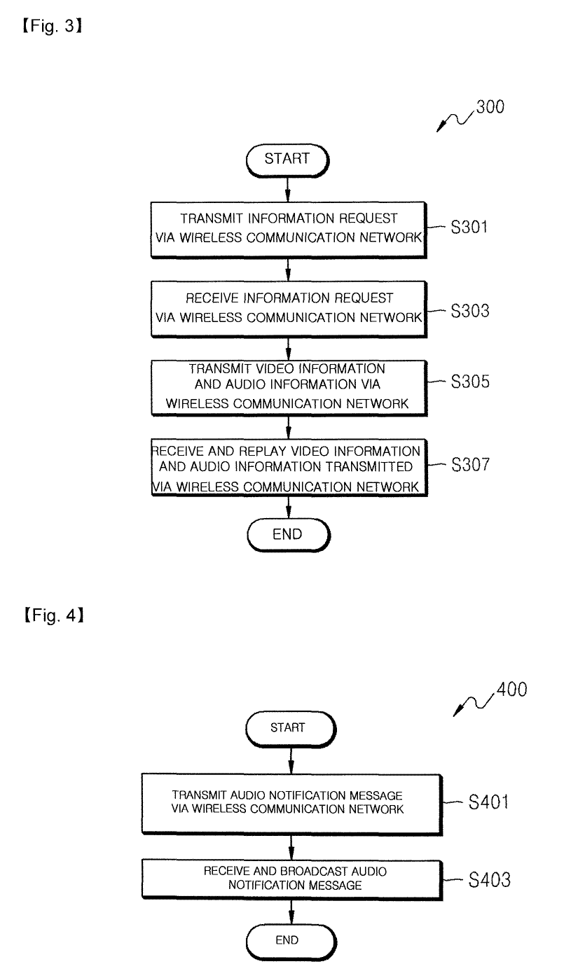

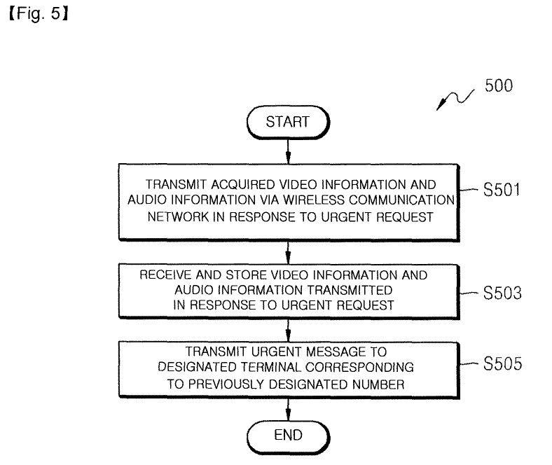

On the other hand, there is provided a method of broadcasting an audio notification message to the child by the guardian. FIG. 4 is a flowchart illustrating operations for broadcasting an audio notification message, the operations further included in the method of FIG. 3.

Referring to FIG. 4, when the guardian wants to broadcast an audio notification message to the child, the guardian transmits the audio notification message to the portable recorder 110 via the wireless communication network by using the user terminal 130 (S401). The portable recorder 110 receives and broadcasts the audio notification message (S403) in such a way that the child may hear the audio notification message transmitted from the guardian.

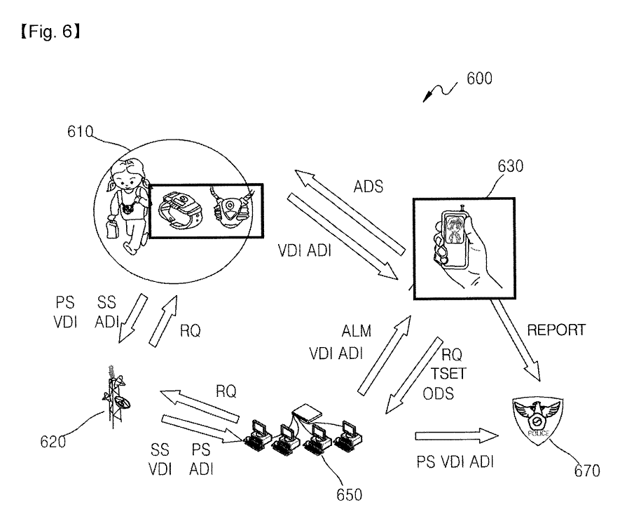

On the other hand, when an urgent situation happens to the child, an urgent request may be generated automatically or using an emergency button (not shown) installed in the portable recorder 110. FIG. 5 is a flowchart illustrating operations for transmitting an urgent message in response to the urgent request, further included in the method of FIG. 3.

Referring to FIG. 5, when the urgent request is generated, the portable recorder 110 transmits video information and audio information acquired and stored in an urgent situation to the management server 150 via the wireless communication network (S501).

The management server 150 receives and stores the video information and audio information transmitted from the portable recorder 110 via the wireless communication network (S503). The management server 150 transmits an urgent message to a designated terminal corresponding to a previously designated number (S505) to notify that a child is placed in an urgent situation.

On the other hand, the embodiments of the present invention can be written as computer programs and can be implemented in general-use digital computers that execute the programs using a computer readable recording medium. Also, the structure of data used in the embodiments of the present invention may be recorded in a computer readable recording medium via various means. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

FIG. 6 is a diagram illustrating a children protection and management system 600 according to another embodiment of the present invention. The children protection and management system 600 is developed to be applied to a real situation in more detail than the children protection and management system 100 of FIG. 1. That is, a code division multiple access/global system for mobile communication (CDMA/GSM) and a global positioning system (GPS) module are installed in a digital video recorder and position information is periodically transmitted to a management server by using an existing mobile communication base station in such a way that a position of an owner of the portable recorder, that is, a child is monitored in real-time and a designated terminal, that is, a mobile terminal of a guardian is automatically notified when the child is out of a designated position.

Referring to FIG. 6, the children protection and management system 600 includes a portable recorder 610, a management server 650, and a user terminal 630.

The portable recorder 610 transmits present position information PS and state information SS to the management server 650 for each predetermined time interval, acquires and stores video information VDI and audio information ADI, and transmits the video information VDI and the audio information ADI via a wireless communication network 620, in response to an information request RQ received via the wireless communication network 620.

As shown in FIG. 6, the portable recorder 610 may be manufactured in the shape of one of a bracelet and a necklace to be easily worn by a user such as children and students.

The portable recorder 610 is a digital video recorder DVR including a micro camera lens and acquiring the video information VDI and the audio information ADI. The portable recorder 610 further includes a wireless communication module capable of using a mobile communication network provided nationwide at present and a GPS module acquiring present position information.

In detail, the portable recorder 610 includes a video information acquisition unit acquiring video information VDI, an audio information acquisition unit acquiring audio information ADI, an information storage unit storing the acquired video information VDI and audio information ADI, a wireless communication module communicating with a wireless communication network 620, receiving an information request RQ, and transmitting the video information VDI and the audio information ADI, and a control unit controlling operations of the video information acquisition unit, the audio information acquisition unit, the information storage unit, and the wireless communication module in response to one of the information request and an emergency signal generated by the operation of an emergency button. Since such configuration of the portable recorder 610 has been described with reference to FIG. 2, though there is a little difference in functions thereof, and those skilled in the art may understand the operation and function of each of elements, a detailed description will be omitted.

The wireless communication network 620 may be embodied as one of a CDMA method, a GSM method, a Wibro method, and a WCDMA method. Using a mobile communication network well provided nationwide at present, there is no required additional network, costs for embodying a system may be more reduced than a system for checking a position of a child by using a radio frequency identification (RFID) tag, and there is no blind spot.

Also, the state information SS generated by the portable recorder 610 includes information on a battery of the portable recorder 610, information on a state of a GPS signal, information on a state of connection of the wireless communication network 620, and information on a state of a test itself of the portable recorder 610.

The management server 650 determines an activity area where the portable recorder 610 exists for each time period in response to activity area setting information TSET transmitted from the user terminal 630 and transmits an alarm signal

ALM to the user terminal 630 when the portable recorder 610 leaves the activity area, based on present position information PS. The alarm signal ALM is one of a text message and an audio signal.

The management server 650 transmits an information request RQ to the portable recorder 610, stores video information VDI, audio information ADI, present position information PS, and state information SS, and transmits the present position information PS, the video information VDI, and the audio information ADI to a National Police Agency (NPA) server 670, in response to a predetermined user order ODS. In this case, the NPA server 670 may be provided in near police boxes or a local police station.

The user terminal 630 transmits an information request RQ to the management server 650 and receives and replays video information VDI and audio information ADI transmitted in response to the information request RQ from the management server 650. Also, the user terminal 630 receives an alarm signal ALM and generates a user order ODS. The user terminal 630 may be a portable device capable of performing wireless mobile communication, such as a mobile phone, a personal digital assistant (PDA), and a notebook computer.

The user order ODS is an order of requesting the management server 650 to transmit video information VDI, audio information ADI, and present position information PS to the NPA server 670.

Hereinafter, operations of the children protection and management system 600 will be described in detail with reference to FIG. 6.

A guardian registers personal information such as gender, name, and age of a child, the number of the user terminal 630, and unique identification of the portable recorder 610 carried by the child, in the management server 650 and determines an activity area of the child by transmitting activity area setting information TSET to the management server 650.

That is, when setting a path as the child is present in a school from 9 am to 3 pm, in a private institute from 3:30 to 5:30, in friend's home from 6 to 7, home from 7:30, and times therebetween for movement and transmitting the path as the activity area setting information TSET to the management server 650, the management server 650 determines the activity of the child.

The activity area may be determined in the management server 650 by using the user terminal 630 or Internet.

When the activity area is determined, the management server 650 receives present position information PS and state information SS of the child from the portable recorder 610 carried by the child. The present position information PS is received from a GPS attached to the portable recorder 610 via the wireless communication network 620.

On the other hand, the portable recorder 610 may recognize position information of its own by communicating with surrounding base stations of the wireless communication network 620 and transmit the position information as the present position information PS to the management server 650. In this case, it is not required to install a GPS in the portable recorder 610.

Now, there is a service of transmitting position information of children to mobile terminals of their parents for a certain time interval when children carry a mobile phone. However, in the case of such service, only present position information is transmitted, different from functions of the system according to an embodiment of the present invention, in which parents control children or an alarm signal ALM is transmitted when the children are out of a designated position.

The management server 650 receiving present position information PS may check whether a child is out of a determined activity area, by comparing the present position information PS with a preset activity area. When setting the portable recorder 610 to transmit present position information PS for a very short time interval, a position of the child may be checked in real-time. When the child leaves the preset active area, the management server 650 transmits an alarm signal ALM to the user terminal 630. When the alarm signal ALM is transmitted to the user terminal 630 as one of a text message or an audio signal, a guardian may check the one of a text message and an audio signal.

The portable recorder 610 further includes a speaker (not shown) receiving an audio signal ADS from the user terminal 630 via the wireless communication network 620 and delivering audio to an owner of the portable recorder 610.

When the child leaves the preset activity area and the alarm signal ALM is transmitted to the user terminal 630, the guardian may instantly transmit the audio signal ADS to the portable recorder 610 by using the user terminal 630. Then, the speaker installed in the portable recorder 610 directly delivers the audio signal ADS sent from the guardian to the child, thereby controlling the child far-off.

The guardian may check a present situation of the child by receiving and replaying the video information VDI and the audio information ADI stored in the portable recorder 610 by using the user terminal 630.

That is, when the guardian transmits an information request RQ to the management server 650 by using the user terminal 630, the management server 650 receives the information request RQ and transmits the information request RQ to the portable recorder 610 via the wireless communication network 620. The portable recorder 610 transmits the stored video information VDI and audio information ADI to the user terminal 630 via the wireless communication network 620 and the management server 650. The guardian may check a surrounding environment or a present situation of the child by replaying the transmitted video information VDI and audio information ADI by using the user terminal 630.

Also, the management server 650 receives and stores the video information VDI, the audio information ADI, the state information SS, and the present position information PS stored in the portable recorder 610.

The present position information PS and the state information SS are automatically received and stored for each predetermined time interval. The video information VDI and the audio information ADI may be continuously stored in the management server 650 as soon as the portable recorder 610 acquires the video information VDI and the audio information ADI or may be stored in the management server 650 when the video information VDI and the audio information ADI stored in the portable recorder 610 are needed or for a certain time interval.

The portable recorder 610 includes an emergency button. The emergency button is allowed to be pushed by a user of the portable recorder 610, that is, the child in a danger situation.

When the emergency button is operated, an emergency signal is generated in the portable recorder 610 and a control unit (not shown) transmits the stored video information VDI and audio information ADI to the management server 650 and the user terminal 630, in response to the emergency signal. In this case, the transmitted video information VDI and audio information ADI may be video information VDI and audio information ADI continuously acquired from a point in time when the emergency signal is generated or may be video information VDI and audio information ADI acquired for a certain amount of time from the point in time when the emergency signal is generated.

The user terminal 630 replays and checks the video information VDI and audio information ADI generated by the operation of the emergency button. The user terminal may send an audio signal ADS to the portable recorder 610 in such a way that the guardian can speak to the child when the emergency button is wrongly pushed or may access the NPA server 670 and report an emergency when the child is placed in an emergent situation.

The user terminal 630 generates a user order ODS and transmits the user order ODS to the management server 650. The user order ODS is an order of requesting the management server 650 to transmit the video information VDI and audio information ADI received by the operation of the emergency button and present position information PS to the NPA server 670. The management server 650 transmits the video information VDI, the audio information ADI, and the present position information PS to the NPA server 670. The NPA server 670 may contact a police box to send police to the scene of the emergent situation.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention may be applied to the field of mobile communication technology.

1. A system for protecting and managing children, the system comprising:
a portable recorder acquiring and storing video information and audio information and transmitting the video information and the audio information via a wireless communication network in response to an information request received via the wireless communication network; and
a user terminal transmitting the information request via the wireless communication network and receiving and replaying the video information and the audio information transmitted in response to the information request.

2. The system of claim 1, wherein the user terminal further transmits an audio notification message via the wireless communication network, and
the portable recorder further receives and broadcasts the audio notification message.

3. The system of claim 1, wherein the portable recorder transmits the video information and the audio information in response to an urgent request via the wireless communication network,
the system further comprising a management server receiving and storing the video information and the audio information transmitted in response to the urgent request and transmitting an urgent message to a designated terminal corresponding to a previously designate number.

4. The system of claim 3, wherein the designated terminal is the user terminal.

5. The system of claim 3, wherein the portable recorder comprises:
a video information acquisition unit acquiring the video information;
an audio information acquisition unit acquiring the audio information;
an information storage unit storing the acquired video information and audio information;
a wireless communication module communicating with the wireless communication network, receiving the information request, and transmitting the video information and the audio information; and
a control unit controlling operations of the video information acquisition unit, the audio information acquisition unit, the information storage unit, and the wireless communication module in response to one of the information request and the urgent request.

6. The system of claim 1, wherein the wireless communication network employs one or more of a code division multiple access (CDMA) method, a global system for mobile communication (GSM) method, a wireless broadband (Wibro) method, and a wideband CDMA (WCDMA).

7. A method of protecting and managing children, the method comprising:
transmitting, by a user terminal, an information request via a wireless communication network;
receiving, by a portable recorder, the information request via the wireless communication network;
transmitting, by the portable recorder, acquired and stored video information and audio information in response to the information request; and
receiving and replaying, by the user terminal, the video information and audio information transmitted via the wireless communication network.

8. The method of claim 7, further comprising:
transmitting, by the user terminal, an audio notification message via the wireless communication network; and
receiving and broadcasting, by the portable recorder, the audio notification message.

9. The method of claim 7, further comprising:
transmitting, by the portable recorder, the video information and audio information via the wireless communication network in response to an urgent request;
receiving and storing, by a management server, the video information and audio information transmitted in response to the urgent request; and
transmitting, by the management server, an urgent message to a designated terminal corresponding to a previously designated number.

10. The method of claim 9, wherein the designated terminal is the user terminal.

11. The method of claim 7, wherein the wireless communication network employs one of a CDMA method, a GSM method, a Wibro method, and a WCDMA method.

12. A system for protecting and managing children, the system comprising:
a portable recorder transmitting present position information and state information for each predetermined time interval, acquiring and storing video information and audio information, and transmitting the video information and audio information via a wireless communication network in response to an information request received via the wireless communication network;
a management server setting an activity area where the portable recorder exists for each time period, in response to activity area setting information, transmitting an alarm signal when the portable recorder leaves the activity area, based on the present position information, transmitting the information request to the portable recorder, storing the video information, the audio information, the present position information, and the state information, and transmitting the present position information, the video information, and the audio information to a National Police Agency (NPA) server in response to a predetermined user order; and
a user terminal transmitting the information request to the management server, receiving and replaying the video information and the audio information transmitted in response to the information request from the management server, receiving the alarm signal, and generating the user order.

13. The system of claim 12, wherein the portable recorder comprises a speaker receiving an audio signal from the user terminal via the wireless communication network and transmitting audio to an owner of the portable recorder.

14. The system of claim 12, wherein the portable recorder transmits the stored video information and audio information to the management server and the user terminal in response to an emergency signal when an emergency button is operated, and
the user terminal replays and checks the video information and the audio information and performs one of accessing the NPA server and generating the user order.

15. The system of claim 12, wherein the alarm signal is one of a text message and an audio signal.

16. The system of claim 12, wherein the wireless communication network employs one of a CDMA method, a GSM method, a Wibro method, and a WCDMA method.

17. The system of claim 12, wherein the portable recorder comprises:
a video information acquisition unit acquiring the video information;
an audio information acquisition unit acquiring the audio information;
an information storage unit storing the acquired video information and audio information;
a wireless communication module communicating with the wireless communication network, receiving the information request, and transmitting the video information and the audio information; and
a control unit controlling operations of the video information acquisition unit, the audio information acquisition unit, the information storage unit, and the wireless communication module in response to one of the information request and the emergency signal generated by the operation of the emergency button.

18. The system of claim 18, wherein the state information comprises information on a state of a battery of the portable recorder, information on a state of a global position system (GPS) signal, information on a state of a connection of the wireless communication network, and information on a state of a self-test of the portable recorder.
